(19) United States
(12) Patent Application Publication
(10) Pub. No.: US 2009/0092820 A1
(43) Pub. Date: Apr. 9, 2009

(54) REINFORCED STRUCTURES AND METHOD OF MANUFACTURE THEREOF

(75) Inventor: Thomas J. Lambers, Prospect, OH (US)

Correspondence Address: ELEY LAW FIRM CO., 7870 OLENTANGY RIVER RD, SUITE 311, COLUMBUS, OH, 43235, US

(73) Assignee: CELL CORE, LLC, Prospect, OH (US)

(21) Appl. No.: 12/245,173

(22) Filed: Oct. 3, 2008

Related U.S. Application Data
(60) Provisional application No. 60/977,405, filed on Oct. 4, 2007.

(51) Int. Cl. B32B 3/26; B29C 65/54; G06F 17/00

(52) U.S. Cl. 428/313.3; 156/63; 428/221; 707/104.1; 707/E17.044

(57) ABSTRACT

A reinforced structure. A plurality of cells having predetermined combinations of shapes and sizes are packed together and arranged into the form of the reinforced structure. A bonding agent is disposed about the cells and links them together as a unit, forming the reinforced structure.

This application claims priority to U.S. provisional patent application No. 60/977,405, filed Oct. 4, 2007, the entire contents of which are hereby incorporated herein by reference thereto.

### FIELD

The present invention relates generally to a system and method for reinforcing structures, in particular to geometrically defined cell members for use in sandwich structures generally having a set of spaced-apart outer walls and a hollow core therebetween.

### BACKGROUND

In recent years laminate core panels having a honeycomb sandwich construction have become increasingly popular in the manufacture of structural panels. These honeycomb sandwich panels comprise a pair of spaced-apart face sheets with a honeycomb core positioned between the face sheets, and with the honeycomb bonded to the face sheets. These honeycomb panels are lightweight and able to withstand considerable compressive loads along the axis of the honeycomb. They are, however, limited in the amount of bending and shear loads that can be carried because the bonding between the face sheets and the honeycomb is essentially a line contact with limited area for bonding the honeycomb and the face sheet.

Other core materials that are used in structural sandwich construction include PVC foam and balsa wood. PVC foam is easily deployed between the face sheets and initially forms a lightweight sandwich. However, foam has limited strength and, in certain applications, repeated stress can eventually break down the foam structurally, leaving a loose sand-like powder positioned between the face sheets, causing the panel to fail with time. Balsa wood is often used as a core material for sandwich construction, but balsa wood has an affinity for moisture which eventually greatly adds to the weight of the overall structure. Furthermore, the wood product breaks down in time due to rotting. These drawbacks make wood a marginal material for use in structural sandwich construction.

### SUMMARY

The present invention comprises reinforced structures and a method for making them. In one embodiment the present invention comprises a panel having outer walls formed by face sheets and a generally hollow core that is at least partially filled with geometrically defined cell members. These geometrically defined cells are bonded together and to the outer walls to form a lightweight, strong panel or core. The cells may be joined together using a bonding agent, which may be a time set or heat set material, to bond the cells one to another and to the outer layers of the panel. The bonding agent may also serve to fill any voids that might exist between cells and between the face of cells and the face sheets.

An object of the present invention is a reinforced structure. A plurality of cells having predetermined combinations of shapes and sizes are packed together and arranged into the form of the reinforced structure. A bonding agent is disposed about the cells and links them together as a unit, forming the reinforced structure.

Another object of the present invention is a method for selecting cells to be bonded together for reinforcing a structure. The steps of the method include establishing a cell characteristic dataset, defining a set of desired properties for the reinforced structure and assigning a weighting factor for each property in accordance with their relative importance. The cells are selected by computing, using the cell characteristic dataset, the desired reinforced structure properties and the weighting factor for each property, a combination of cells which, when bonded together, provide the desired properties for reinforcing the structure.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 shows a “peanut” shaped cell according to an embodiment of the present invention;

FIG. 2 shows a “triple peanut” shaped cell according to an embodiment of the present invention;

FIG. 3 shows a “dodecahedron” shaped cell according to an embodiment of the present invention;

FIG. 4 shows a “double dodecahedron” shaped cell according to an embodiment of the present invention;

FIG. 5 shows a “triple dodecahedron” shaped cell according to an embodiment of the present invention;

FIG. 6 shows a “tetrahedron” shaped cell according to an embodiment of the present invention;

FIG. 7 shows a “double tetrahedron” shaped cell according to an embodiment of the present invention;

FIG. 8 shows a “triple tetrahedron” shaped cell according to an embodiment of the present invention;

FIG. 9 shows a “quad tetrahedron” shaped cell according to an embodiment of the present invention;

FIG. 10 shows a “partial torus” shaped cell according to an embodiment of the present invention;

FIG. 11 shows a “cone” shaped cell according to an embodiment of the present invention;

FIG. 12 shows a “double cone” shaped cell according to an embodiment of the present invention;

FIG. 13 shows a “torus” shaped cell according to an embodiment of the present invention;

FIG. 14 shows a “Icosahedron” shaped cell according to an embodiment of the present invention;

FIG. 15 shows a “cube” shaped cell according to an embodiment of the present invention;

FIG. 16 shows a “octahedron” shaped cell according to an embodiment of the present invention;

FIG. 17 shows a “cylinder” shaped cell according to an embodiment of the present invention;

FIG. 18 shows a “conical-ended cylinder” shaped cell according to an embodiment of the present invention;

FIG. 19 shows a “pyramid” shaped cell according to an embodiment of the present invention;

FIG. 20 shows a “sphere” shaped cell according to an embodiment of the present invention;

FIG. 21 shows a “half-sphere” shaped cell according to an embodiment of the present invention;

FIG. 22 shows a “quarter-sphere” shaped cell according to an embodiment of the present invention;

FIG. 23 shows an “eighth-sphere” shaped cell according to an embodiment of the present invention;

FIG. 24 shows a “penta-tetra” shaped cell according to an embodiment of the present invention;

FIG. 25 shows a “wedge” shaped cell according to an embodiment of the present invention;

FIG. 26 shows a “double wedge” shaped cell according to an embodiment of the present invention;

FIG. 27 shows a “wedge with tetra ends” shaped cell according to an embodiment of the present invention;

FIG. 28 is a flow diagram showing a method for selecting cells for a particular application according to an embodiment of the present invention;

FIG. 29 is a flow diagram showing a method for making cells according to an embodiment of the present invention;

FIG. 30 is a view in section of a reinforced structure according to an embodiment of the present invention; and

FIG. 31 is a flow diagram showing a method for manufacturing the structure of FIG. 30.

### DETAILED DESCRIPTION

The disclosed invention incorporates a number of improvements over the teachings of the inventor's previous U.S. Pat. No. 5,100,730, the entire disclosure of which is hereby incorporated by reference thereto.

The disclosed invention according to one embodiment consists of individually manufactured solid and/or hollow polygonal shaped closed cells that vary in shape, size, materials and material thickness depending on the application and its required specifications including, without limitation, cost, strength and weight characteristics. Quantities of individual cells are placed in a mold or form of virtually any desired finished part shape, including complicated three-dimensional and curved shapes. The mold may have the finished part's outer layer or “skins” already in place, or the cells can be molded to form stand-alone parts without skins.

Various methods may be used to pack the cells in the mold, including vibrating the mold, allowing the natural settling and/or packing of the cells and the alignment and nesting of the cells to each other, and in the case of finished composite parts, to the skins.

Once the mold is filled to the desired level with cells a bonding agent is introduced, which bonds the cells to each other and the skin surfaces of the finished composite part. The bonding agent may be selected from a variety of materials depending on the cell materials, the finished part skin materials and the application and required strength, weight, and cost characteristics. Non-limiting examples include plastic resins such as epoxy, vinyl ester, polyester, polyurethane, glue, etc.

Selected combinations of the variables of cell shape, cell size, cell material, solid cells, cell wall thickness in the case of hollow cells, bonding agent materials, and manufacturing methods create a large number of possible configurations to meet widely varying requirements for finished parts comprising reinforced structures. This allows the reinforced structure to be optimized and tailored for a given application by optimizing each of the variables to best meet the application requirements.

### Cell Shape

There are many possible cell shapes that can be used to manufacture a reinforced structure. Factors that determine which shapes are preferred over others include the shapes' natural alignment, nesting, interlocking and bonding to each other as well as the finished part skins in the case of composite parts. Some example shapes are described in detail below, but other shapes are anticipated within the scope of the invention.

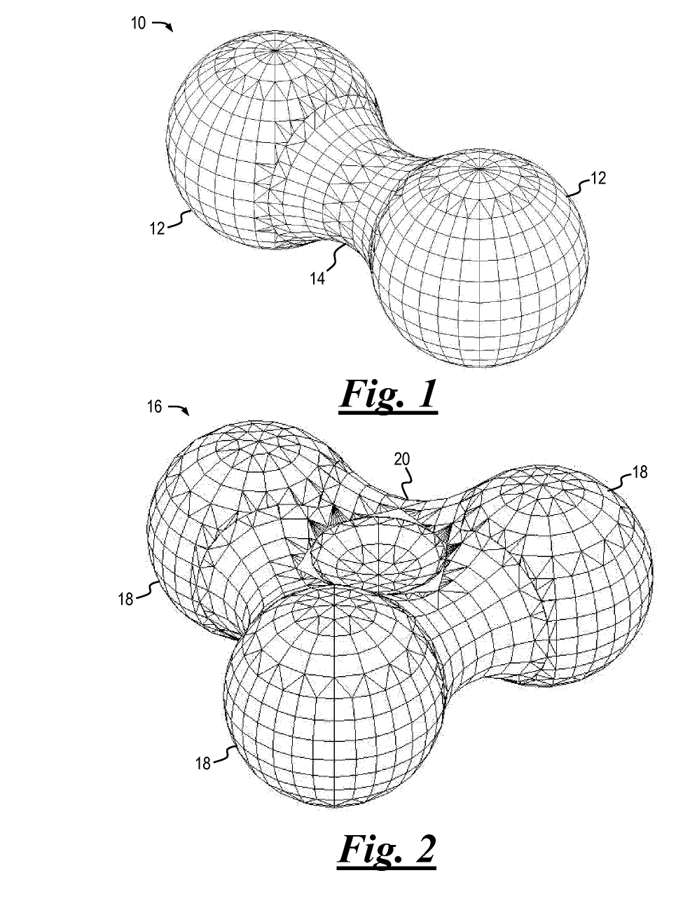

With reference to FIG. 1, a “peanut” shaped cell 10 consists of two spheres 12 with a web or waist 14 extending therebetween, all molded as a unit. The outside diameters of spherical ends 12 are typically generally the same radius as the concave radius of the web portion 14. This optimizes the random nesting and interlocking of the cells 10 to each other, and provides surface-to-surface bonding therebetween when a bonding agent is applied, as opposed to limited line-to-line, or point-to-point bonding. In addition, the overall length of cell 10, and the minimum sectional diameter of the web portion 14 varies depending on the material thickness used for manufacture of the cells. For hollow cells 10, a greater wall thickness results in a cell that is overall shorter in length with a larger outside sectional diameter at the waist 14. Conversely, thinner wall thickness produces a longer overall cell length and smaller outside diameter at the waist 14. These dimensional variations may be optimized for a particular application of a reinforced structure. Cells 10 also inherently provide structural strength by mechanically “hooking” to or engaging each other (i.e., interlocking and nesting together).

With reference to FIG. 2, a “triple peanut” cell 16 consists of three spheres 18 connected by a web 20, all molded as a unit. Similar to the peanut cell 10, the outside diameters of the spheres 18 of cell 16 are generally the same radius as the concave radius of the web portion 20. This maximizes the random nesting and interlocking of the cells 16 to each other and provides surface-to-surface bonding when a bonding agent is applied, as opposed to limited line-to-line, or point-to-point bonding therebetween. For hollow cells 16, the overall length of the cell and the minimum sectional diameter of the web portion 20 of the cell varies depending on the material thickness used for manufacture of the cells. Greater wall thickness requires the cell 16 to be overall shorter in length, with a larger sectional diameter at the web 20. Conversely, thinner wall thickness requires a longer overall cell 16 length and smaller diameter at the web 20. These dimensional variations may be optimized for each application. Third, cells 16 inherently provide structural strength by mechanically “hooking” to or engaging each other (i.e., interlocking and nesting together).

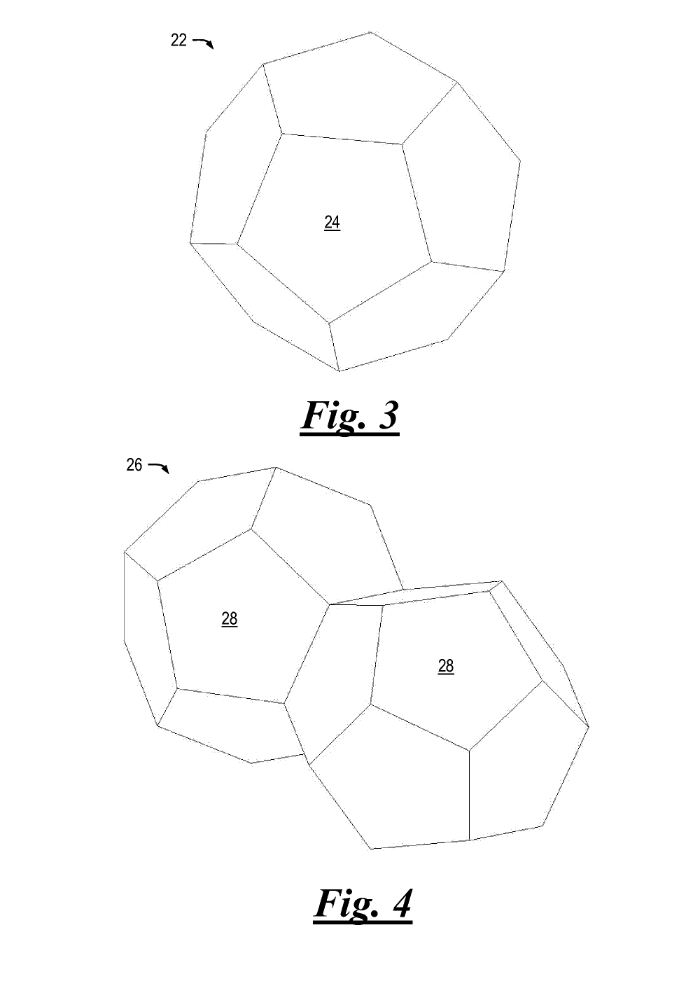

With reference to FIG. 3, a dodecahedron cell 22 consists of a generally spherical shape comprising twelve generally planar pentagon-shaped surfaces 24 joined together along their edges. A characteristic of the dodecahedron cell 22 is that the surfaces 24 of a group of dodecahedron cells in close proximity inherently nest to each other with a close flat-to-flat contact between their adjoining surfaces. If the reinforced structure includes outer layers the surfaces 24 also inherently nest with planar portions of the interior surface of the outer layers. This flat-to-flat contact between cells (and, optionally, between the cells and the outer layers) provides high bonding strength in tensile and shear when a bonding agent is applied.

With reference to FIG. 4, a double dodecahedron or “double do” cell 26 is comprised of two dodecahedrons 22 (FIG. 3) connected to each other and sharing a common edge around the perimeter of one of the planar pentagonal areas 28. If hollow, cell 26 is also hollow where the two dodecahedrons 22 join and there is no surface bridging across a waist. There are two components to the structural strength provided by this cell shape. First, like the dodecahedron cell 22 the double do cells 26 inherently nest to each other with a close flat-to-flat contact between adjoining surfaces 28. The surfaces 28 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied. In addition, cells 26 inherently provide structural strength by mechanically “hooking” to or engaging each other (i.e., interlocking and nesting together).

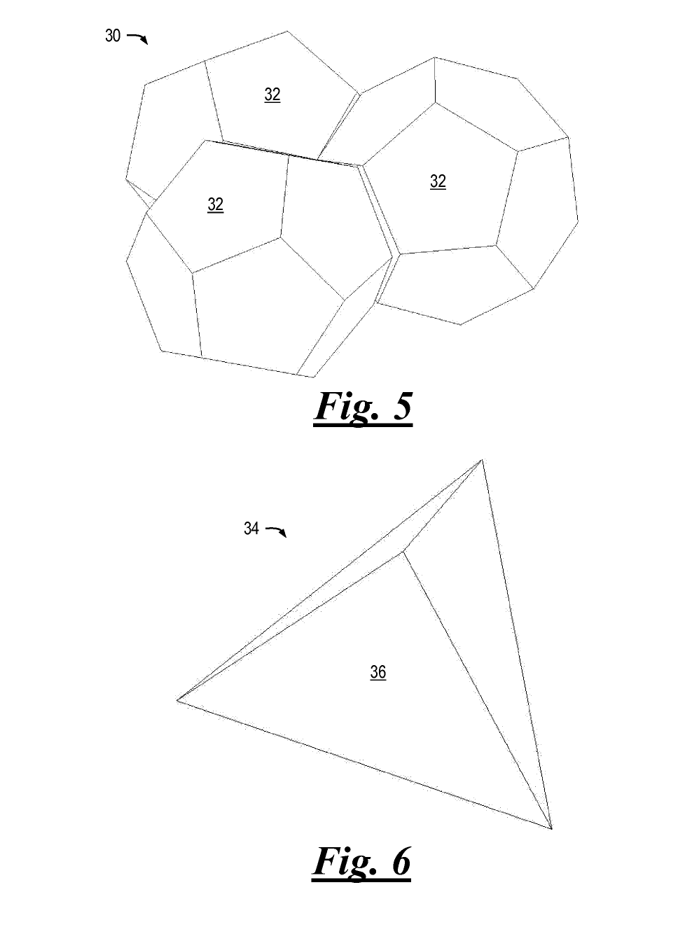

With reference to FIG. 5, similar to the double do cell 26, a “triple do” cell 30 is comprised of three dodecahedrons 22 (FIG. 3) connected to each other and sharing common edges around the perimeter of generally planar pentagonal areas 32. If hollow, the cell 30 is hollow where the dodecahedrons 22 join and there are no surfaces bridging across a waist. There are two components to the structural strength provided by this cell shape. First, like the dodecahedron cell 22 and the double do cell 26, triple do cells 30 inherently nest to each other with a close flat-to-flat contact between adjoining surfaces 32. The surfaces 32 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied. Second, like the double do cells 26, cells 30 inherently provide structural strength by mechanically “hooking” to or engaging each other (i.e., interlocking and nesting together).

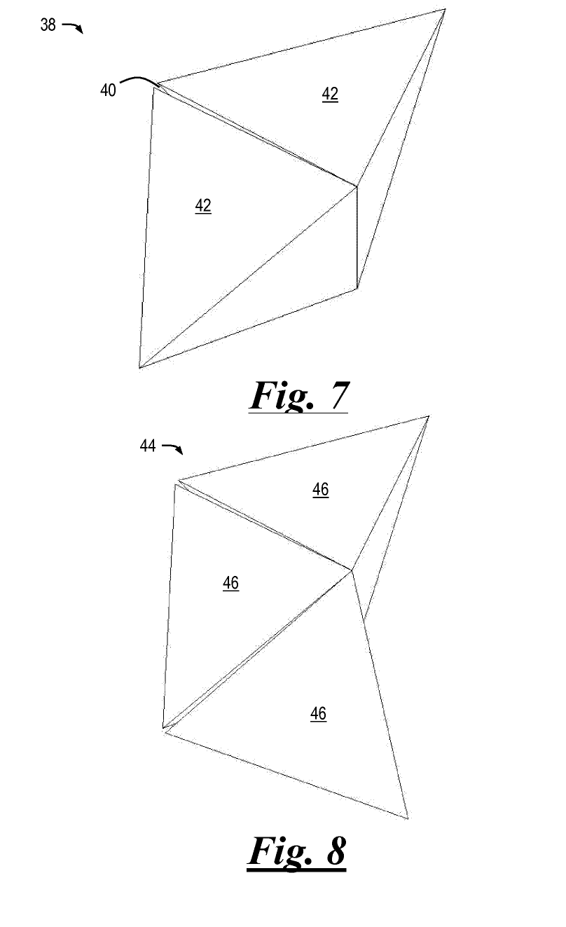

With reference to FIG. 6, a tetrahedron or “tetra” cell 34 consists of four planar triangular surfaces 36 joined along their edges. A characteristic of the tetra cell 34 is that the cells inherently nest to each other with a close flat-to-flat contact between adjoining surfaces 36. The surfaces 36 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied.

With reference to FIG. 7, a “double tetra” cell 38 is comprised of two tetrahedron cells 34 (FIG. 6) connected to each other and sharing a common edge around the perimeter of one of their planar triangular surface areas 40. If hollow, double tetra cell 38 is hollow where the two tetra cells 34 join and there is no surface bridging across a waist. A characteristic of the double tetra cell 38 is that the cells inherently nest to each other with a close flat-to-flat contact between adjoining surfaces 42. The surfaces 40 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied.

With reference to FIG. 8, a “triple tetra” cell 44 is comprised of three tetrahedrons 34 (FIG. 6) connected to each other and sharing common edges around the perimeter of their planar triangular areas 46. If hollow, the cell 44 is hollow where the tetra cells 34 join and there is no surface bridging across a waist. There are two components to the strength created by this cell shape. First, like the tetra cells 34 the triple tetra cells 44 inherently nest to each other with a close flat-to-flat contact between adjoining surfaces 46. The surfaces 46 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied. Second, like the peanut cell 10 and double do cell 26, triple tetra cells 44 inherently provide structural strength by mechanically “hooking” to or engaging each other (i.e., interlocking and nesting together).

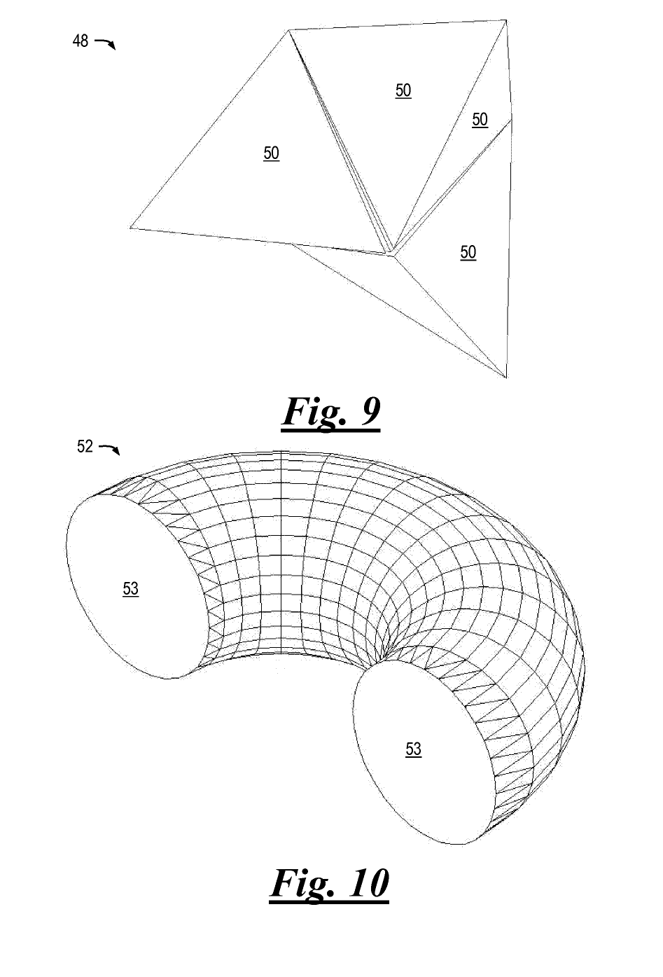

With reference to FIG. 9, a “quad tetra” cell 48 is comprised of four tetrahedron cells 34 (FIG. 6) connected to each other and sharing common edges around the perimeter of their planar triangular areas 50. If hollow, cell 48 is hollow where the tetra cells 34 join and there is no surface bridging across a waist. There are two components to the strength created the shape of quad tetra cell 48. First, like the tetra cell 34 the quad tetra cells 48 inherently nest to each other with a close flat-to-flat contact between adjoining surfaces 50. The surfaces 50 also inherently nest with planar portions of the interior surface of finished-part outer layers if outer layers form part of the reinforced structure. This flat-to-flat contact between cells (and, optionally, between the cells and the outer layers) provides high bonding strength in tensile and shear when a bonding agent is applied. Second, like the peanut cell 10 and double do cell 26, quad tetra cells 48 inherently provide structural strength by mechanically “hooking” to or engaging each other (i.e., interlocking and nesting together).

With reference to FIG. 10, a “partial torus” shaped cell 52 comprises a curved cylinder. The ends 53 of the cylinders can be generally flat as shown in the figure, or they may be rounded, open-ended or closed off. The total arc of the curve of cell 52 can vary from about 30 degrees to 180 degrees, although arcs of greater and lesser curvature are also envisioned. There are two components to the strength created by this cell shape. First, the outside diameter of the cylinder in section is generally the same radius as the inside radius of the torus curve. This maximizes random nesting and interlocking of cells 52 to each other and provides line-to-line bonding when a bonding agent is applied, as opposed to limited point-to-point bonding. Second, cells 52 inherently provide structural strength by mechanically “hooking” to or engaging each other (i.e., interlocking and nesting together).

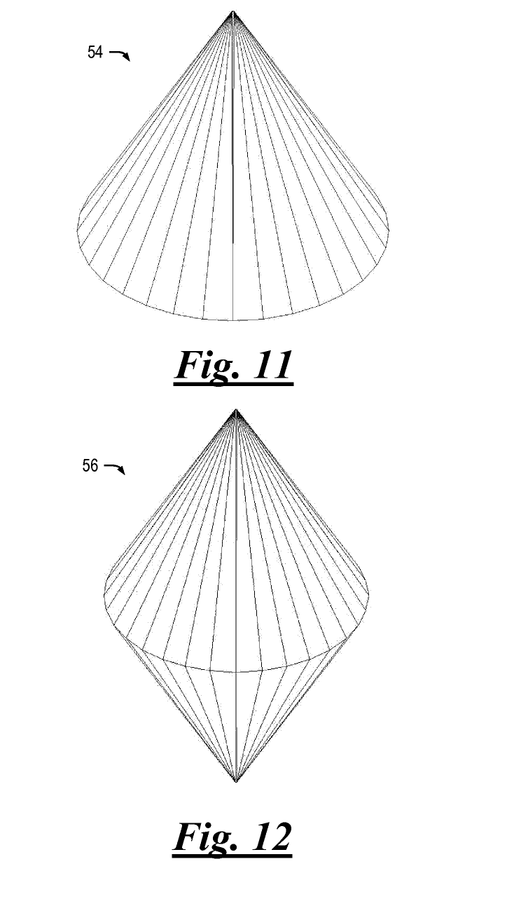

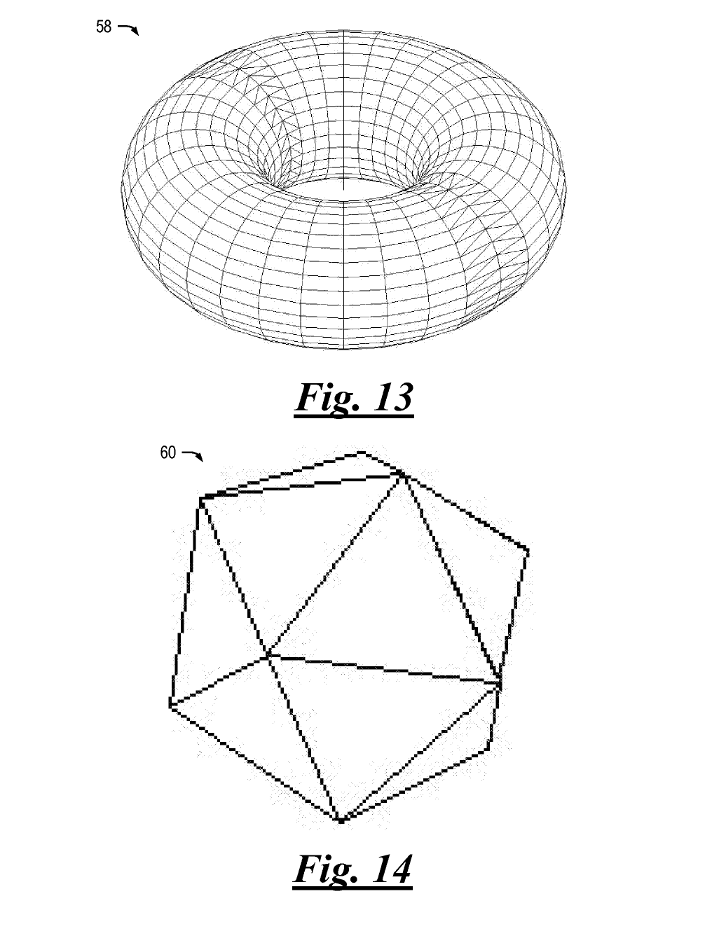

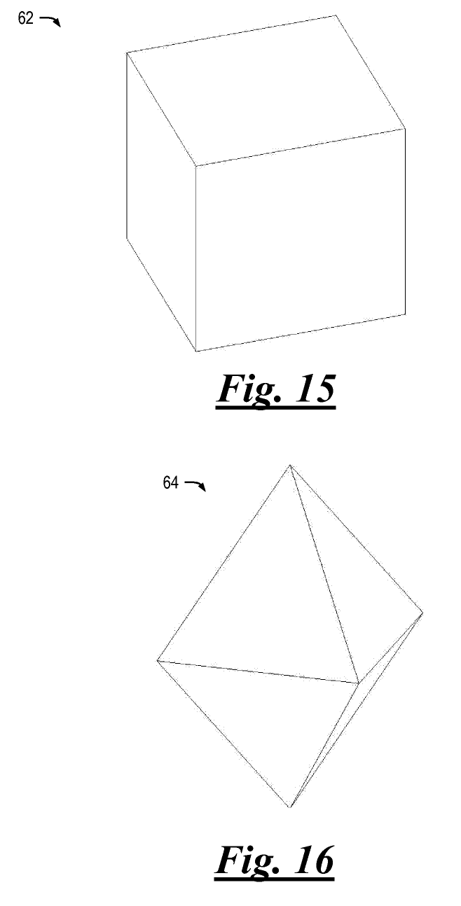

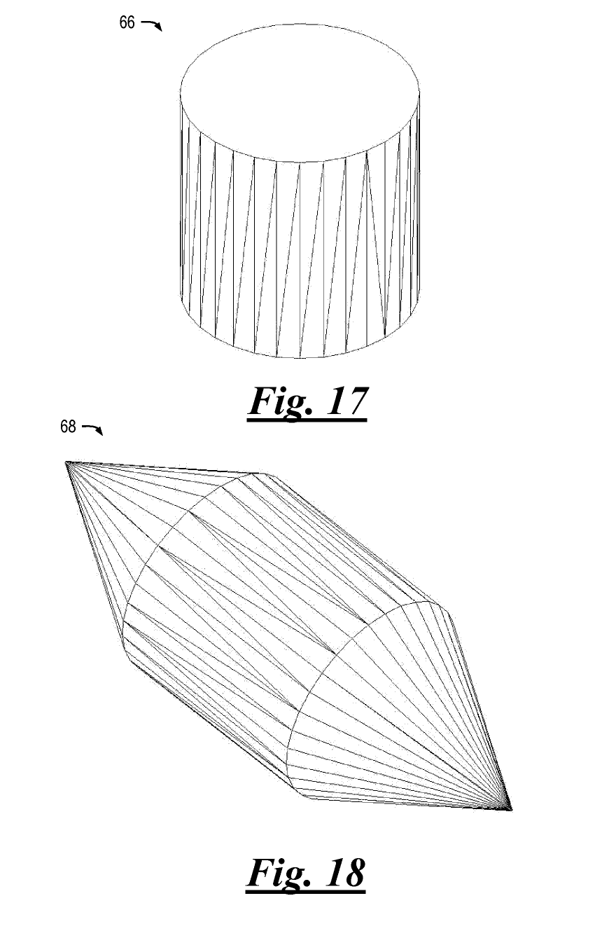

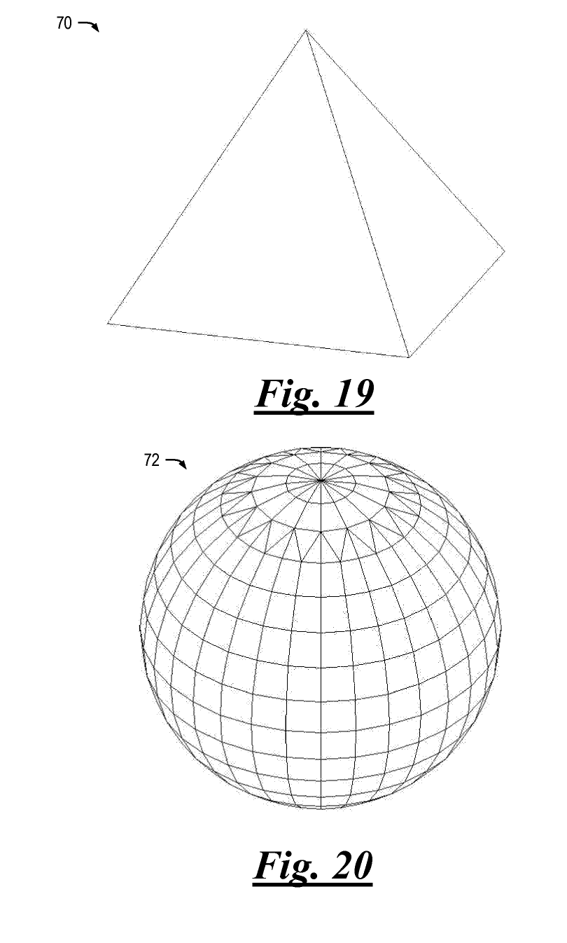

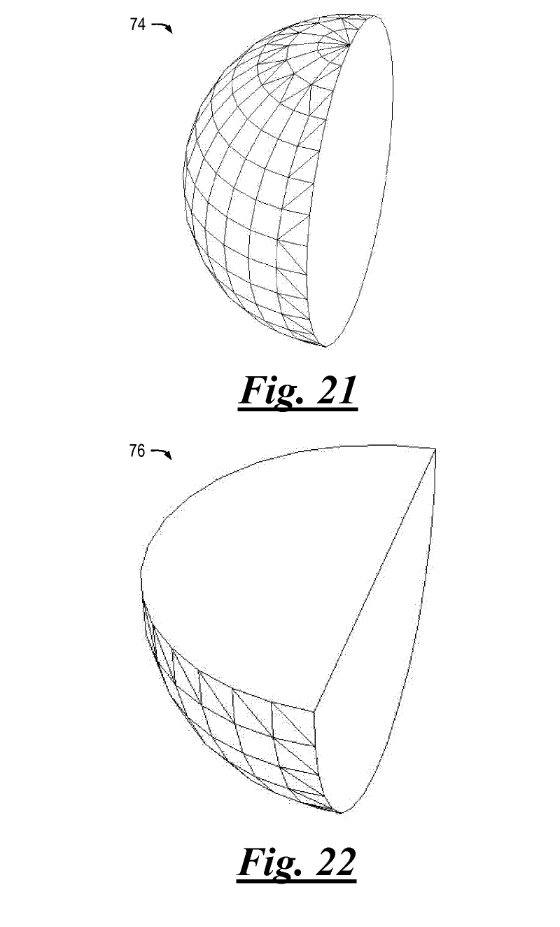

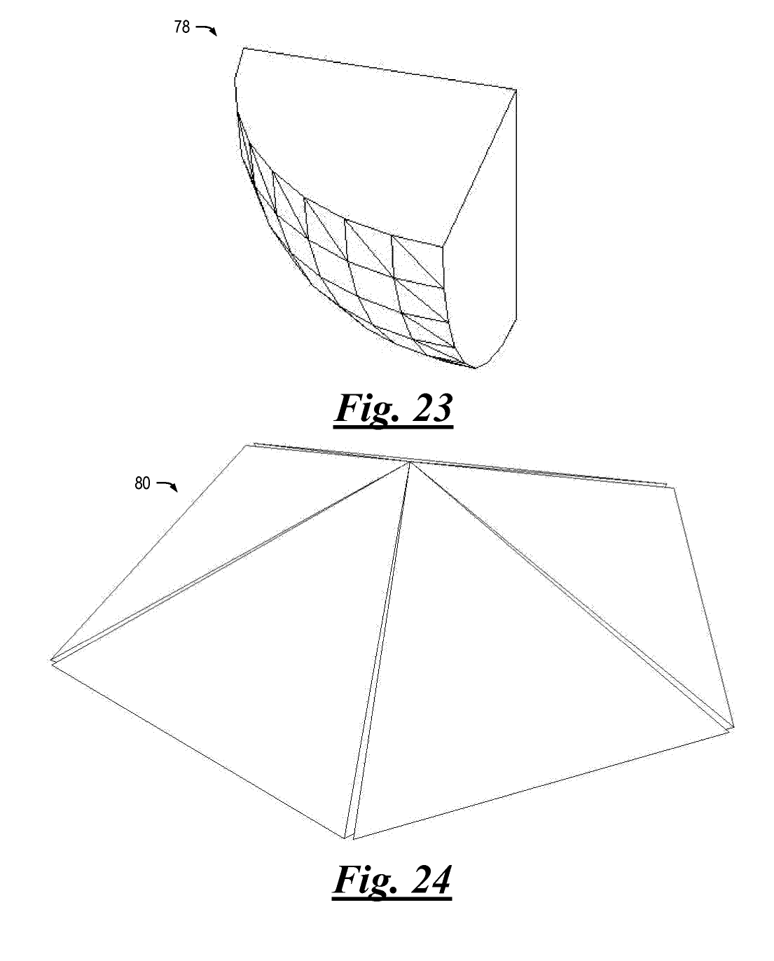

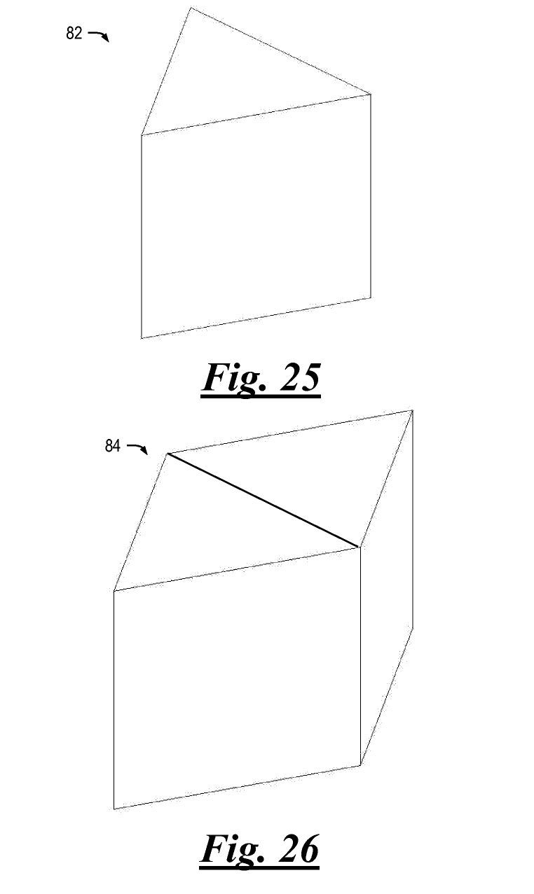

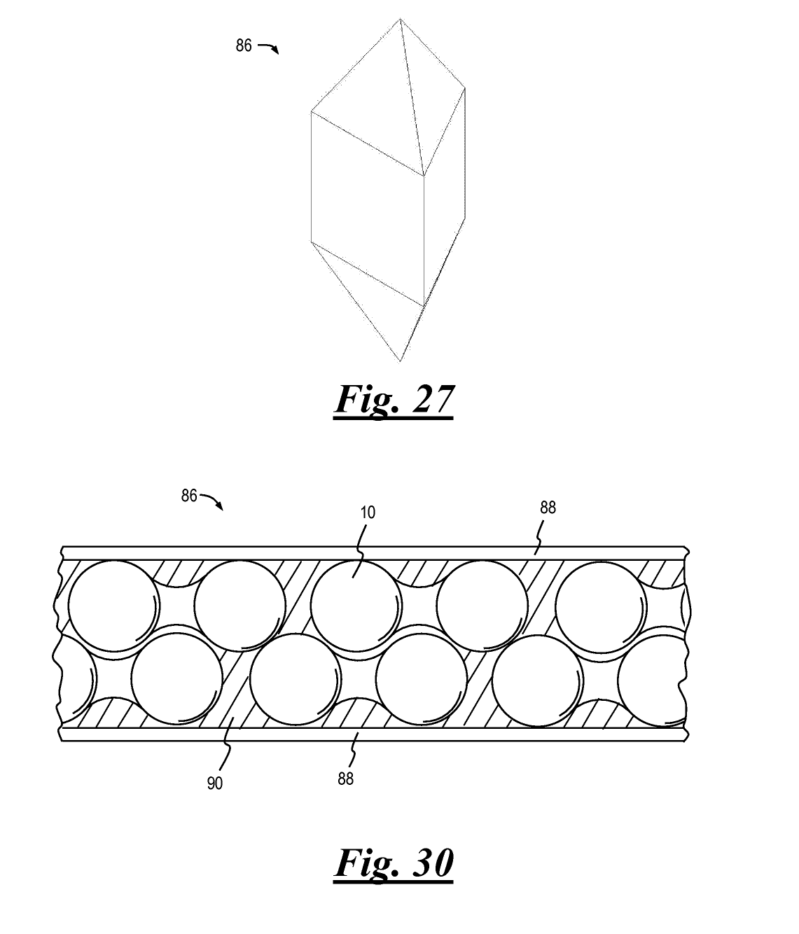

With reference to FIGS. 11-27, it will be appreciated that there are additional symmetrical and non-symmetrical shapes of cells that may be employed to accomplish similar functions. FIG. 11 shows a “cone” shaped cell 54. FIG. 12 shows a “double cone” shaped cell 56. FIG. 13 shows a “torus” shaped cell 58. FIG. 14 shows an “icosahedron” shaped cell 60. FIG. 15 shows a “cube” shaped cell 62. FIG. 16 shows a “octahedron” shaped cell 64. FIG. 17 shows a “cylinder” shaped cell 66. FIG. 18 shows a “conical-ended cylinder” shaped cell 68. FIG. 19 shows a “pyramid” shaped cell 70. FIG. 20 shows a “sphere” shaped cell 72. FIG. 21 shows a “half-sphere” shaped cell 74. FIG. 22 shows a “quarter-sphere” shaped cell 76. FIG. 23 shows an “eighth-sphere” shaped cell 78. FIG. 24 shows a “penta-tetra” shaped cell 80. FIG. 25 shows a “wedge” shaped cell 82. FIG. 26 shows a “double wedge” shaped cell 84. FIG. 27 shows a “wedge with tetra ends” shaped cell 86. In addition, other shapes may include, without limitation, “S-”shaped cells, “J-”shaped cells and spiral shaped cells (not shown).

### Cell Shape Mixtures

In determining the optimum mix of shapes the efficiency of the finished part is a primary consideration. As used herein, the “efficiency” of the finished-part reinforced structure is generally defined as the optimum combination of required characteristics for the part, such as the highest shear strength for a given weight, the highest strength/weight ratio for a given cost, etc. With reference to FIGS. 1-27, it has been observed that mixes of cell shapes can have beneficial strength, weight and cost effects upon the reinforcement of a finished-part reinforced structure. For example, a mix of peanut cells 10 and triple peanut cells 16 can provide significant reinforcement strength to a finished structure while also reducing the cost and weight of the structure. Mixing peanut cells 10 and/or triple peanut cells 16 with partial torus cells 52 also creates good results. Mixing of dodecahedron cells 22 with double do cells 26 and/or triple do cells 30 can increase the efficiency of the finished parts. Similar results are achieved with varying mixes of tetrahedron cells 34, double tetra cells 38, triple tetra cells 44 and quad tetra cells 48. Further, mixes of the dodecahedron group (i.e., cells 22, 26 and 30) with cells from the tetrahedron group (i.e., cells 34, 38, 44 and 48) provides very good results. As can be seen from the foregoing, there are numerous possible cell shape mixes that create varying results and which can be tailored for product optimization.

The mix ratio varies with the desired results and characteristics, as determined by the specific application. For example, one application may achieve optimum results with a mix consisting of 40% triple peanut cells 16 and 60% peanut cells 10. Another application may be best served with 10% triple do cells 30, 15% double do cells 26, 25% dodecahedron cells 22, 5% quad tetra cells 48, 10% triple tetra cells 44, 15% double tetra cells 38 and 20% tetrahedron cells 34. As this example demonstrates, cell shape mixes can be very complicated with respect to determination of the optimum mix for different applications.

### Cell Sizes

It has been observed that there are optimum cell sizes which vary in relationship to the size of the finished part (i.e., the reinforced structure). As a general rule, using smaller than optimum size cells for a given finished part increases its strength characteristics but also increases the weight and cost of the finished part. Conversely, using a larger than optimum cell size will reduce the weight and cost of the finished part but will also reduce the strength characteristics of the finished part. Therefore, to achieve certain optimal characteristics such as compressive strength, weight and cost, there is an optimum cell size. If certain desired characteristics are changed slightly, such as tensile strength, weight and cost, a different cell size mix may be required. As a non-limiting example, if a reinforced structure is made with cells between a pair of outer layers spaced about an inch apart, the optimum cell size may be in the range of about a quarter of an inch.

The optimum cell size required to achieve specific characteristics also varies with the cell shape. As a non-limiting example, to achieve a specific strength-to-weight ratio for a reinforced structure made with cells between a pair of outer layers spaced about an inch apart may require peanut cells 10 about a quarter of an inch in size, whereas dodecahedron cells 22 may be sized at about three sixteenths of an inch and tetrahedron cells 34 may be about three eighths of an inch in size. As a general rule, if the finished part requires a higher strength for a given thickness of the reinforced structure, this can be achieved by using smaller cell sizes, but with an increase in weight and cost.

The minimum size of cells for a particular application are primarily determined by the material and cell wall thickness. It has been observed that, as the cell size decreases, when manufacturing cells with a given material thickness, the wall of the cell becomes a greater percentage of the total volume of the cell and therefore becomes less efficient with regard to strength and weight of the finished part. However, this is not a straight-line relationship. Rather, as the cell size is reduced the overall efficiency of the cell is slowly reduced until a point is reached where the efficiency drops dramatically. This can be best understood by appreciating that, as the cell size is reduced with a given material thickness of a finished part, the cell has a smaller and smaller hollow volume and the cell consequently comes closer to becoming a solid. Of course, some applications may require the use of solid cells to meet the required strength requirements.

Because of the restrictions of available material thickness for manufacturing cells, cells are typically at least about an eighth of an inch in size, depending upon the cell shape selected. Solid cells can be manufactured at much smaller sizes.

The maximum size of the cells is determined by the requirements of the application. Realistically, manufacturing cells up to approximately “softball” size cells or even larger are envisioned.

### Cell Size Mixes

Further optimization may be achieved by mixing cell sizes for a particular reinforced structure. It has been shown that better results are achieved for a given finished-part reinforced structure with a given void to fill by starting with cells that are actually larger than the optimum cell size as described above and mixing them with a quantity of one or two smaller sizes of cells.

As an example, a finished part with a 4-inch void between outer layers is to be filled with reinforcement cells. Rather than selecting one-inch size peanuts 10 (which may be acceptable for this application) a mix of cells may be selected, such as 20% two-inch sized peanut cells, 30% half-inch sized peanut cells and 50% eighth-inch sized peanut cells. These mixes create higher strength and higher strength/weight ratios and therefore more efficient and desirable finished parts.

### Cell Shape and Size Mixes

A wide variety of configurations of reinforcing structures may be formed by utilizing mixtures comprising mixes of cells having one or more shapes as well as one or more sizes.

### Cell Materials

A wide variety of materials from which to manufacture the cells may be selected. For hollow cells it is preferred that the material be in sheet form. This includes a wide variety of plastics, fiberglass with resins, ceramics, paper, metal, etc. Again, the material used for the manufacture of the cells is determined by the application for the reinforced structure. Solid cells can be made from an even wider variety of materials.

### Cell Wall Thickness

In the case of hollow cells the thickness of the cell wall is also a factor to be considered in light of the required characteristics for any given application. Thicker material creates cells with thicker walls, which provides higher strength, but at an increased weight and cost. Thinner material creates cells with thinner walls, which are lower in cost and weight, but also have decreased strength.

It has been observed that for any given cell size there is an optimum wall thickness which provides the greatest strength/weight ratio. For a given cell size, if the wall is thinner than optimum, the strength of the finished part is reduced in greater proportion than the weight and/or cost. If the walls are thicker than optimum, the weight and/or cost is increased in greater proportion than the strength.

Cells may be made using a wide variety of material thicknesses, allowing for a corresponding wide variety of cell sizes, each of which may be optimized for any given application. For example, cells may be manufactured with very thin materials and walls, ranging to solid cells, thereby creating optimum cells down to very small sizes.

### Cell Shape, Size and Material Mixes

Adding the material and cell wall thickness variables to the mixes of cell shape and size creates an even greater number of mixes for application optimization.

### Outside Surface Texture of Cells

The texture of the outer surface of a cell, such as its roughness, is controllable and may vary widely from extremely smooth to very rough. A rough surface dramatically enhances the bonding of the cells to each other and the finished parts' skin surfaces, thereby resulting in a structurally robust finished part. Conversely, a very smooth surface enhances settling and/or compacting of cells into each other. Again, these variables are preferably optimized for a particular application of a reinforced structure.

### Cell Colors

Cells may be made of a variety of colors and/or patterns either by the use of colored resins and materials, or color pigments added to the materials. Alternatively, a color system such as paint may be applied to the outer surface of the cells.

### Cell Selection

As the foregoing discussion indicates, a wide variety of available cell configurations may be drawn from when designing a particular reinforced structure. Moreover, reinforced structures have widely varying design criteria, depending upon such factors as the expected environment, loading, size and shape. Consequently, it is not practical to provide herein a particularized list of cell characteristics matched to particular finished products. Instead, a process such as the one shown in FIG. 28 may be employed. At step s100 a cell characteristic dataset is developed and maintained. The dataset is preferably a “living document” comprising ongoing structured data, gathered for various cell configurations in carrying out the present invention. The dataset may include, without limitation, metrics relating to weight, tensile strength, flexibility, compressive strength, shear strength, material composition, material cost, reliability, durability, buoyancy, vibration control and material environmental characteristics for various cells and mixtures of cells having the previously discussed cell criteria (i.e., size, thickness, shape, etc.).

At steps s102, s104, s106 and s108 various desirable properties for a particular reinforced structure are categorized and given a weighting factor corresponding to their relative importance. Such properties may include, for example, the aforementioned weight, tensile strength, compressive strength, shear strength, material composition, material cost and material environmental characteristics.

At step s110 the defined and weighted properties of steps s102-s108 are compared to the dataset of step s100 to determine the optimum cell characteristics for a particular reinforced structure. Preferably, a computer executing a predetermined algorithm is utilized, the algorithm taking into account the relative importance of the various select properties and tradeoffs defined in the dataset to arrive at the optimum cell characteristics. The process of step s110 may be implemented in the form of a “data warehouse,” which is well-known in the art and thus will not be elaborated upon further herein.

At step s112 the results of step s110 may be provided to a user in any visually perceivable format, such as a computer screen or a printed report, and may be formatted in one or more convenient ways, such as lists, charts and graphs indicating the optimum cell shapes, sizes, mixture ratios, materials and so forth.

### Bonding Agent

Once the mold is filled to the desired level with cells a bonding agent is introduced. The bonding agent may be selected from a variety of materials depending on the cell materials, the finished part skin materials and the specifications for the finished part, such as desired strength, weight, and cost. For example, the bonding material may be plastic resins such as epoxy, vinyl ester, polyester, polyurethane, or many other materials, such as glue. The bonding agent may be applied by a variety of methods depending upon the specified cost, strength and weight characteristics for the finished part.

In a first method of applying the bonding agent a liquid bonding agent is simply poured in the top of a cell-filled mold, allowing gravity to distribute the bonding agent throughout the cells, any excess being allowed to drain from the bottom of the mold. The mold may optionally be rotated during this process, allowing gravity to better distribute the bonding agent.

In a second method of applying the bonding agent the cells are “trapped” in a mold and the mold is then completely filled with liquid resin. Once completely filled openings in the bottom of the mold are opened, allowing any excess resin to drain away. This method ensures the complete coating of all cell and skin surfaces within the mold.

In a third method of applying the bonding agent a bonding agent may be injected among the cells in a mold by use of pressure nozzles. This can also be supplemented by the use of vacuum to ensure an even distribution of the resin.

In a fourth method of applying the bonding agent a predetermined amount of bonding agent may be introduced into the mold. The mold is then sealed. Once sealed, the mold is placed into roto-molding equipment where the mold is rotated and spun three-dimensionally. This method utilizes a combination of gravity and centrifugal forces to distribute the bonding agent throughout the mold. This process also controls the distribution of more resin to specific areas within the part, such as along outer layers.

In a fifth method of applying the bonding agent the individual cells can be coated with a dry powder type resin prior to packing the mold with the quantity of cells. Once the cells are packed in the mold the entire mold is then placed in an oven (optionally being rotated) such that the powder coating then melts and fuses the cells and outer layers to each other. The finished part is then allowed to cool.

Strength can be added to the bonding and bonding agent by introducing fibers in the liquid bonding agent itself. These fibers may be made of a wide variety of materials such as carbon, Kevlar®, glass and ceramic, among others. Furthermore, scrap material from the cell manufacturing process may be ground into fibers and mixed with the liquid bonding agent prior to introduction to finished part molds.

### Manufacture of Cells

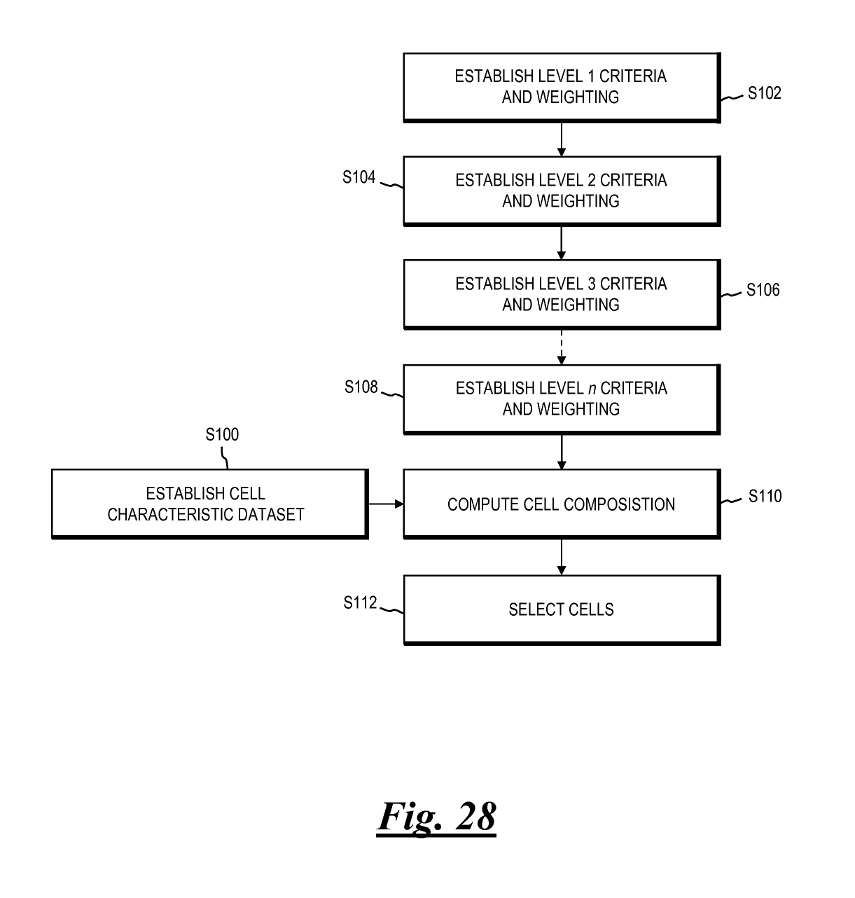

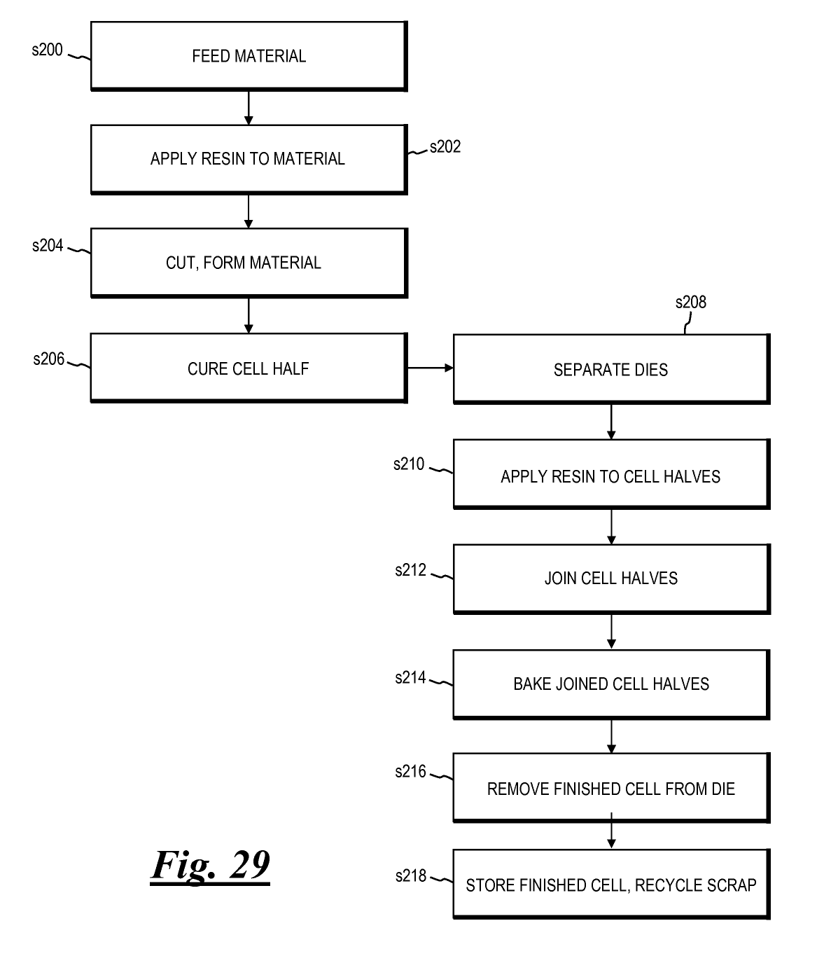

There are several methods of manufacturing the cells, including blow molding, injection molding, roto-molding, die molding and others. One non-limiting example method of manufacture of individual hollow cells is accomplished by the process shown in FIG. 29.

At step s200 a roll fiber material is placed on spindles at a starting end of a production line, allowing the continuous feeding of the fiber sheet material into the process. At step s202, liquid resin is then sprayed onto the sheet fiber material and is allowed to saturate the fiber material. The saturated sheet material then passes through sets of squeeze rollers. These rollers may be made adjustable for any given material thickness and serve to urge the liquid resin into and through the sheet fiber material, as well as to squeeze out any excess. For maximum strength and minimum weight and cost, any resin impregnated fiber sheet material preferably has a predetermined amount of resin in the fiber. The amount varies with the materials used, but it should be noted that excessive resin increases weight and cost with little or no increase in strength in the finished part. Conversely, an insufficient amount of resin results in a dramatic reduction in strength in the finished part.

At step s204 the resin impregnated fiber sheet then passes between a male punch and a female die, which are then pressed together. This process cuts the sheet material by the use of shear edges to form the flat perimeter edges of each individual cell and then presses the flat material into the cell shape in one step. Alternatively, the cutting and forming steps may be separated into two distinct steps. The male and female dies are preferably a continuous procession of flat die plates linked to each other. The cells are made in two halves so that there are two continuous sheet material rolls passing through two sets of male and female dies simultaneously forming the top and bottom halves of the cells. This allows the continuous linear process of forming the two halves of the cells.

At step s206 both of the continuous belts of male and female dies with the cell material pressed between them, passes through an oven which is of sufficient size, and adjusted to a predetermined temperature to properly “set” or “cure” the cell halves.

At step s208, upon exiting the oven a brief vacuum is applied to the female dies and the male die or “punches” are separated, leaving the cell half material in the female dies. The male dies then return to the beginning of the production line to repeat the process.

At step s210 the female dies containing the cell halves then pass by a device that applies a predetermined amount of resin material to the exposed edges of the cell halves.

At step s212 the linked female die plates are then pressed together, face to face, thereby putting the two cell halves together and forming a “butt” joint and a “seam” on each individual cell. This is done while the edge bonding material is still “wet” with the resin. The resin then flows together and fuses along the edges, thereby joining the two halves.

At step s214 the joined female die plates then enter another oven. This oven is set at a predetermined temperature and of sufficient size to bring the die plates to a predetermined temperature for a predetermined length of time to cause the setting or hardening of the thermo-set resin bonding the cell edges forming the cells.

At step s216, upon leaving the oven the female dies are separated and air pressure applied to blow out the finished cells and scrap material from the dies. The female dies then return to the beginning of the production line to repeat the process.

At step s218 the scrap material and finished cells fall through sifters separating scrap sheet from the cells. The cells fall into bins and are stored as finished product. The scrap material may be fed through grinders to recycle fiber material for mixing with the bonding agent.

There are two elements of interest with regard to the manufacture of the maximum strength, lightest weight, or highest strength/weight ratio finished parts. First, fiber sheet with resin binder materials may be used to manufacture the individual cells. This material and process creates cells with long fiber reinforcement, which produces high strength with low weight and therefore a high strength/weight ratio. Second, manufacturing with thin sheet materials allows for thinner walls as compared to other manufacturing methods such as roto-molding, injection molding, etc.

### Manufacture of Finished Parts

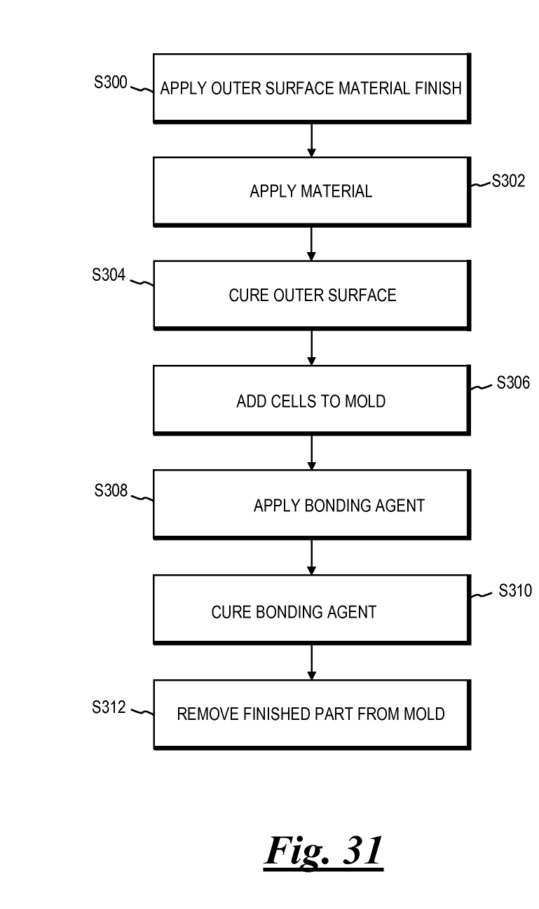

The general arrangement of an example reinforced structure 86 (i.e., “finished part”) is shown in section in FIG. 30. Reinforced structure 86 is of sandwich construction, comprising a pair of spaced-apart outer layers or “skins” 88 forming a void therebetween that is substantially filled by a plurality of cells. Peanut cells 10 and skins 88 may be bonded together with a bonding agent 90, forming a unitary assembly. In FIG. 30 peanut cells 10 are shown for purposes of illustration, but any of the previously discussed cell configurations may be used.

Multi-part female molds may be used to manufacture finished parts. The molds may be made of a variety of materials such as plastic, metal, wood, ceramic or fiberglass and are made to the desired shape(s) of the finished external surface. With reference to FIGS. 30 and 31, finished parts may be fabricated utilizing the following example process.

At step s300 an external finish material is applied (typically sprayed) to the surface of female mold parts. Fiber reinforced material is then applied to the female mold parts at step s302 and cured at step s304 to form outer layers or “skins” 88. At step s306 female mold parts are coupled to each other, and reinforcement is applied tying the surfaces together along their mating seams. A quantity of desired cells (peanut cells 10 in FIG. 30) are then poured into the void within the mold, completely filling the void between the finished skins 88. At step s308 a bonding agent 90 is applied and set at step s310, thereby bonding the individual cells 10 to each other as well as to the skins 88 to create a unitary, fully “cored” finished part 86. At step s312 the mold halves are separated and the finished part is removed. In the case of manufacturing fully cored parts with pre-shaped skins, such as aluminum, the aluminum skins are simply used as the mold and filled with the desired cell mix.

### Manufacture of Unfinished Parts

Reinforced structures according to the various embodiments of the present invention are strong and may be provided without outer layers or skins. With this process female molds are used the same way as described above but without the application of skin material to the molds. This process can also create “core” parts having complex shapes to be applied to “finished” parts at a later time, such as by an end manufacturer. One such product may be “raw” core material in sheet form (half-inch, three-quarter-inch one-inch thick etc.) in two foot by four foot sheets as an example. This may be marketed as a “core” material for use by manufacturers in a format they are already accustomed to working with. With this “sheet” material a flexible bonding agent such as polyurethane may be used, thereby creating sheet core material that is robust yet flexible enough to be layed in compound curve areas, a significant improvement for end-use manufacturers that currently use stiff, flat sheet material. Alternatively, bulk amounts of cells may be manufactured for sale to end manufacturers to manufacture finished parts.

### Conclusion

From the above description of the invention, those skilled in the art will perceive improvements, changes, and modifications in the invention. Such improvements, changes, and modifications within the skill of the art are intended to be covered. For example, although the finished part 86 of FIG. 30 shows a generally planar reinforced structure, it will be appreciated that reinforced structures produced according to the present invention may have complex, three-dimensional geometries and contours, the geometries and contours being established by the molds used to form the structures.

What is claimed is:

1. A reinforced structure, comprising:
a plurality of cells having predetermined combinations of shapes and sizes, the cells being packed together and arranged into the form of the reinforced structure; and
a bonding agent disposed about the cells and linking them together as a unit, forming the reinforced structure.

2. The reinforced structure of claim 1 wherein the cells comprise at least one of peanut-shaped cells and triple-peanut-shaped cells.

3. The reinforced structure of claim 2 wherein the cells comprise at least one of dodecahedron-shaped cells, double dodecahedron-shaped cells and triple dodecahedron-shaped cells.

4. The reinforced structure of claim 3 wherein the cells comprise at least one of tetrahedron-shaped cells, double tetrahedron-shaped cells, triple tetrahedron-shaped cells and quad tetrahedron-shaped cells.

5. The reinforced structure of claim 4 wherein the cells comprise at least one of partial torus-shaped cells, cone-shaped cells, double cone-shaped cells, torus-shaped cells, icosahedron-shaped cells, cube-shaped cells, octahedron-shaped cells, cylinder-shaped cells, conical-ended cylinder-shaped cells, pyramid-shaped cells, sphere-shaped cells, half-sphere-shaped cells, quarter-sphere-shaped cells, eighth-sphere-shaped cells, penta-tetra-shaped cells, wedge-shaped cells, double-shaped cells, and wedge-shaped cells having tetra ends.

6. The reinforced structure of claim 1, further comprising a pair of spaced-apart outer layers, the cells being located therebetween.

7. The reinforced structure of claim 1 wherein the cells are hollow.

8. The reinforced structure of claim 7 wherein the cells have a predetermined thickness.

9. The reinforced structure of claim 1 wherein the cells are solid.

10. The reinforced structure of claim 1 wherein the cells are made from a plurality of materials.

11. The reinforced structure of claim 1 wherein the cells have a predetermined outer surface texture.

12. The reinforced structure of claim 1 wherein at least a portion of the cells have at least one predetermined color.

13. A method for selecting cells to be bonded together for reinforcing a structure, comprising the steps of:
establishing a cell characteristic dataset;
defining a set of desired properties for the reinforced structure;
assigning a weighting factor for each property in accordance with their relative importance; and
computing, using the cell characteristic dataset, the desired reinforced structure properties and the weighting factor for each property, a combination of cells which, when bonded together, provide the desired properties for reinforcing the structure.

14. A method for forming a reinforced structure, comprising the steps of:
selecting a plurality of cells having predetermined combinations of shapes and sizes;
packing the cells together and arranging them into the form of the reinforced structure; and
applying a bonding agent to the cells to link them together as a unit, forming the reinforced structure.

15. The method of claim 14, further comprising the step of locating the cells between a pair of spaced-apart outer layers.

16. The method of claim 14, further comprising the step of selecting hollow cells.

17. The method of claim 16, further comprising the step of selecting hollow cells having predetermined thicknesses.

18. The method of claim 14, further comprising the step of selecting solid cells.

19. The method of claim 14, further comprising the step of selecting cells made of a plurality of materials.

20. The method of claim 14, further comprising the step of selecting cells having a predetermined outer surface texture.
